(19) United States
(12) Patent Application Publication
(10) Pub. No.: US 2016/0048791 A1
(43) Pub. Date: Feb. 18, 2016

(54) INTELLIGENT PROCESS FLOWS

(71) Applicant: Microsoft Technology Licensing, LLC, Redmond, WA (US)

(72) Inventors: Palak Kadakia, Redmond, WA (US); Karan Srivastava, Bellevue, WA (US); Kunal Garg, Bellevue, WA (US); Nirav Shah, Bothell, WA (US); Shashi Ranjan, Redmond, WA (US)

(21) Appl. No.: 14/458,937

(22) Filed: Aug. 13, 2014

(51) Int. Cl. G06Q 10/06

(52) U.S. Cl. CPC G06Q 10/06316

(57) ABSTRACT

Configuration information, indicating how a computing system process is configured, is analyzed to obtain calculated metrics and recommendations for improving the process. The calculated metrics and recommendations are surfaced on a user interface display, along with user input mechanisms that can be actuated to take action in order to implement one or more of the recommendations. If a user input mechanism is actuated, the corresponding action is performed to modify the process to implement the recommendation, and the process display is updated to show the modification.

### BACKGROUND

Computer systems are currently in wide use. Some such computer systems facilitate process flows. The process flows can be used to guide a user through a process.

By way of example, some such computer systems include business systems. Business systems can include, for instance, customer relations management (CRM) systems, enterprise resource planning (ERP) systems, line-of-business (LOB) systems, among others. These types of systems implement business processes. In doing so, they present user interface displays (or forms) that operate on underlying business entities (records that represent items in the business system). Some examples of entities can include, for instance, a customer entity which describes and represents a customer. A vendor entity describes and represents a vendor. A business opportunity entity describes and represents a business opportunity. A quote entity describes and represents a quote. These are only examples. The entities can be objects with callable methods, or items with more rich functionality.

Users that use business systems attempt to perform business processes. One example of a business process is a sales process. The sales process, when implemented by a business system, guides a user through various stages from developing a lead to closing a deal and obtaining payment. There are often many different business processes implemented by a business system. The business processes can act on internal or external data, perform steps within or external to the business system, and be automated, manual or a hybrid where some steps are automatic while others are manual.

The discussion above is merely provided for general background information and is not intended to be used as an aid in determining the scope of the claimed subject matter.

### SUMMARY

Configuration information, indicating how a computing system process is configured, is analyzed to obtain calculated metrics and recommendations for improving the process. The calculated metrics and recommendations are surfaced on a user interface display, along with user input mechanisms that can be actuated to take action in order to implement one or more of the recommendations. If a user input mechanism is actuated, the corresponding action is performed to modify the process to implement the recommendation, and the process display is updated to show the modification.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a block diagram of one example of a business process configuration system.

FIG. 3 is a block diagram of one example of a data analytics system.

FIG. 4 is a flow diagram illustrating one example of the operation of the business process configuration system in surfacing analytics and recommendations during configuration of a business process.

FIGS. 4A-4E are examples of user interface displays.

FIG. 5 is a flow diagram illustrating one example of the operation of the data analytics system in performing analytics and generating recommendations during the configuration process.

FIG. 6 is a flow diagram illustrating one example of the operation of an application system during runtime operation of a business process.

FIGS. 6A-6C are examples of user interface displays.

FIG. 7 is a flow diagram illustrating one example of the operation of the data analytics system during runtime operation of a business process.

FIG. 8 is a block diagram showing one example of the architecture illustrated in FIG. 1, deployed in a cloud computing architecture.

FIGS. 9-11 show various examples of mobile devices.

FIG. 12 is a block diagram of one example of a computing environment.

### DETAILED DESCRIPTION

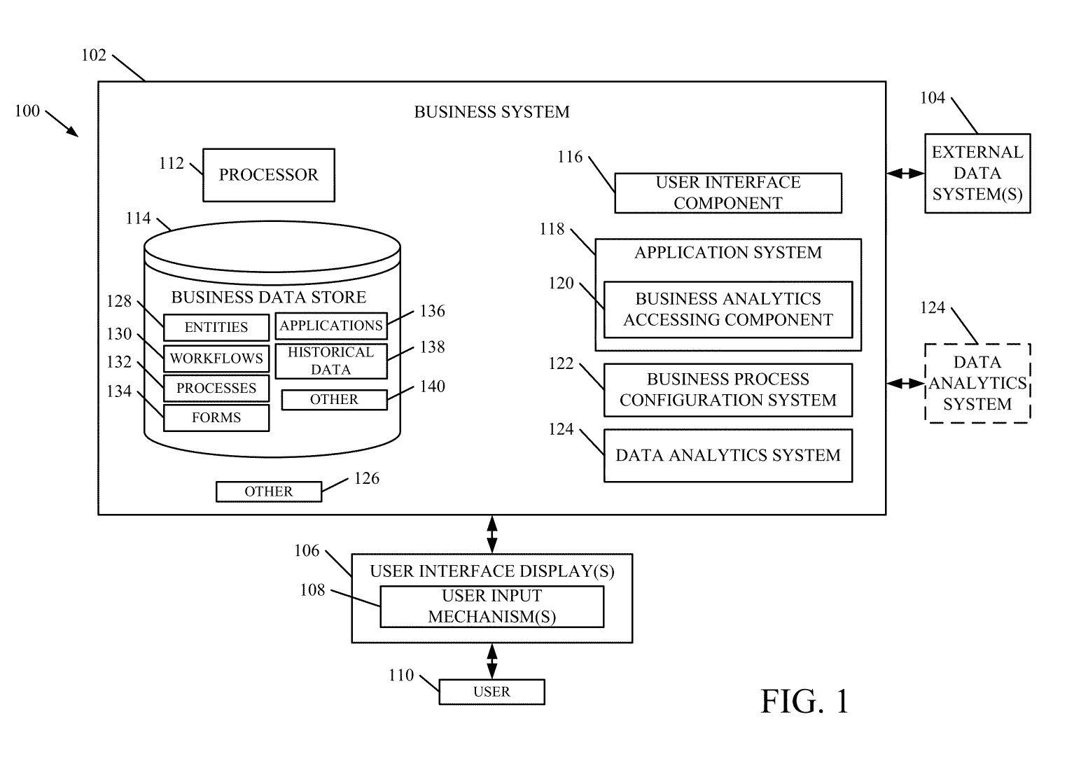

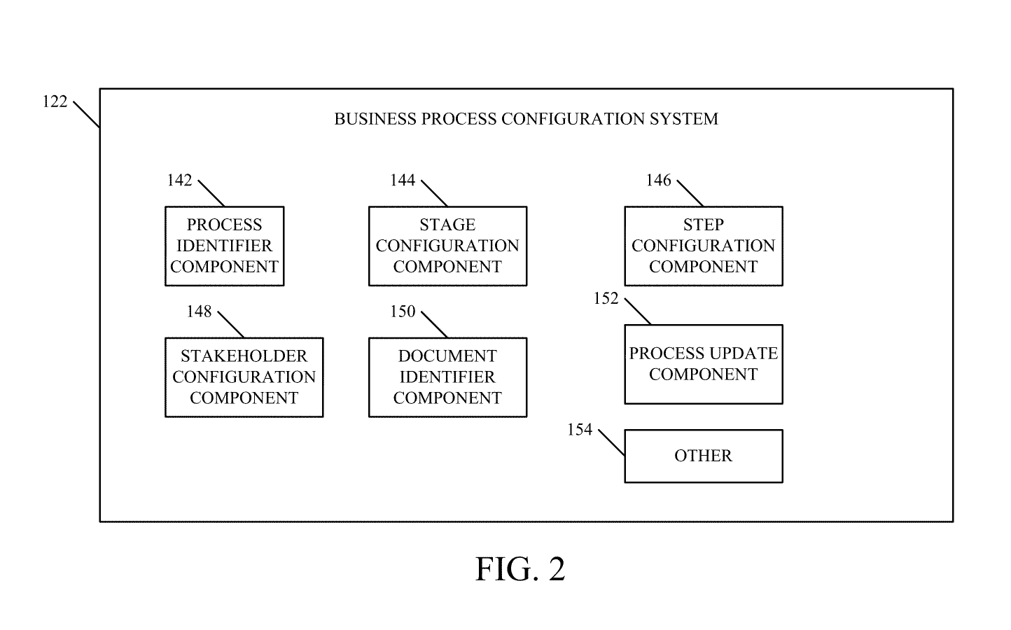

FIG. 1 is a block diagram of one example of a computing system architecture 100. Architecture 100 includes business system 102 that is shown accessing external data systems 104. Business system 102 illustratively generates user interface displays 106 with user input mechanisms 108 for interaction by user 110. When user 110 is a developer or an administrator (or sometimes even an end user), user 110 can provide configuration inputs to configure various portions of business system 102. When user 110 is an end user, user 110 also illustratively interacts with user input mechanisms 108 to control and manipulate business system 102 during runtime.

Business system 102 illustratively includes processor 112, data store 114, user interface component 116, application system 118 (which itself includes business analytics accessing component 120), business process configuration system 122, data analytics system 124, and it can include other items 126. FIG. 1 shows that data analytics system 124 can be internal to system 102, external to it, or split with some functionality internal and other functionality external. In the example shown in FIG. 1, business data store 114 illustratively includes entities 128, workflows 130, processes 132, forms 134, applications 136, historical data 138, and it can include other items 140 as well.

User interface component 116 (either by itself or under the control of other items in business system 102) illustratively generates the user interface displays 106 with user input mechanisms 108. Application system 118 illustratively runs applications 136 which can operate on various data in business data store 114, or external data, and run workflows 130 and processes 132. Applications 136 are illustratively business applications. Therefore, they can include general ledger applications (or a variety of other accounting applications), customer service applications, inventory tracking applications, sales process applications, opportunity tracking applications, among a wide variety of other applications. In running workflows 130 and processes 132, applications 136 can access entities 128, historical data 138, external data, and other business data records 140, and generate visualizations using forms 134 or other items.

Business process configuration system 122 illustratively provides user input mechanisms that allow user 110 to configure business process 132. In doing so, system 122 can access data analytics system 124 to obtain calculated metrics (such as key performance indicators—KPIs) and recommendations of how to improve the process being configured.

The KPIs and recommendations can be displayed during the configuration process (and actions can be taken to implement the recommendations) and during the runtime process. This is described in greater detail below. A brief overview will be provided first.

Data analytics system 124 can access the various data in business data store 114 or external data. The calculated metrics and recommendations are surfaced for user 110, during the configuration process, along with user input mechanisms 108 that correspond to each of the recommendations. User 110 can actuate the user input mechanisms 108, and business process configuration system 122 performs corresponding actions to take the recommendations and to modify the process being configured, accordingly.

It should also be noted that, during runtime, when application system 118 is running a given process 132, business analytics accessing component 120 also illustratively accesses data analytics system 124 to obtain calculated metrics and recommendations. Those metrics and recommendations are surfaced for the user 110 during runtime, along with user input mechanisms 108 corresponding to each recommendation. Again, during runtime, when the user actuates a user input mechanism corresponding to a recommendation, business process configuration system 122 takes action to modify the corresponding process based upon the recommendations, and the user interface 106 for the process is modified to show the modified process.

FIG. 2 is a block diagram showing one example of business process configuration system 122 in more detail. In the example shown in FIG. 2, system 122 illustratively includes a process identifier component 142, which allows the user to identify a given process. System 122 includes stage configuration component 144, step configuration component 146, stake holder configuration component 148, document identifier component 150, process update component 152, and it can include other items 154. Process identifier component 142 illustratively generates user input mechanisms that allow the user to identify a given process to be configured or modified. Stage configuration component 144 generates user input mechanisms that can be actuated by the user in order to configure a set of stages through which the business process is to proceed. Step configuration component 146 illustratively generates user input mechanisms that can be actuated by the user to configure steps that are to be taken, within each stage. Stake holder configuration component 148 illustratively generates user input mechanisms that can be actuated to identify a set of stake holders for the process being configured. Document identifier component 150 illustratively generates user input mechanisms that can be actuated to identify documents that are relevant to the process. Process update component 152 illustratively updates the process being configured, based upon the inputs from the user. In addition, process update component 152 can update a running process when a user provides an input indicating that a recommendation is to be taken. In that case, process update component 152 automatically updates the running process, to take an action corresponding to the recommendation, and the modified process is then displayed to the user.

In one example, all of the configuration inputs received through system 122 are used to generate metadata that defines the business process. Applications that are run by application system 118 access that metadata to run the business process corresponding to a given application. When changes are made to the process, the changes can be made to the metadata and thus reflected in the process.

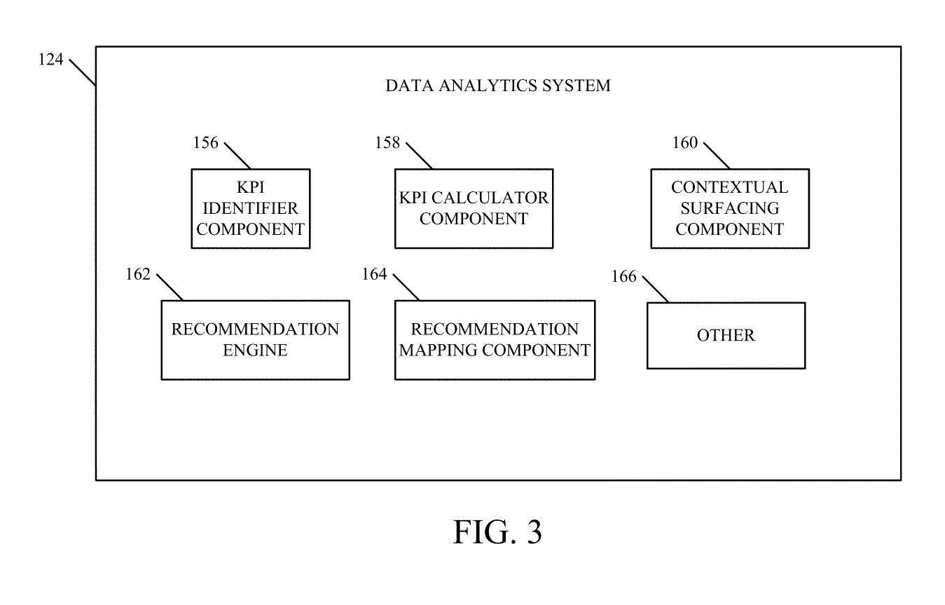

FIG. 3 is a block diagram showing one example of data analytics system 124 in more detail. System 124 illustratively includes key performance indicator (KPI) identifier component 156, KPI calculator component 158, contextual surfacing component 160, recommendation engine 162, recommendation mapping component 162, and it can include other items 166 as well. KPI identifier 156 illustratively accesses historical data and other data in business system 102, and it can access data from external data systems 104 as well. As a business process is being configured, KPI identifier component 156 uses business analytics to identify certain metrics (KPIs) that may be useful to a user using such a business process. It can also identify KPIs that are indicative of the overall performance of the business process (such as the likelihood that a process will be successful, the estimated time that a process should take, among other things). The particular KPIs that are calculated for a given process may vary. Different KPIs may indicate a likelihood of success for different processes. They may indicate different timing for different processes, or they may indicate other metrics of interest, depending upon the specific type of process. The KPIs can be identified using historical data, using heuristics, using machine learning systems, or using a wide variety of other types of business analytic components.

KPI calculator component 158 illustratively calculates values for the KPIs that are identified. For instance, if one of the KPIs has a likelihood of success of a given business process, then KPI calculator component 158 access data that is used to calculate a value for that KPI so that it can be surfaced for the user.

Contextual surfacing component 160 illustratively identifies the different contexts in the different business processes where different KPIs will be surfaced. In one example, the full set of KPIs for a given business process are surfaced on a process display throughout the entire process. In another example, different KPIs are surfaced during different stages or steps of the process. Contextual surfacing component 160 can determine which KPIs to surface in which different contexts based on configuration inputs by an administrator or developer or user, based upon heuristics, rules, machine learning or using other techniques.

Recommendation engine 162 illustratively accesses configuration information indicating how a given business process is configured, and state information indicative of a current state of a process, and generates recommendations for improving the performance of the process. By way of example, recommendation engine 162 may be accessed by business process configuration system 122, during the configuration process. It may identify processes that have been used successfully. It may make recommendations for adding or eliminating stages or steps within a stage of a business process to improve its performance. The improvement in performance can be determined in different ways. For instance, improvement may be to expedite a process, to increase the chances of success of a given process, to increase the accuracy of the process, to reduce work associated with a process, or other things or various combinations of things (like decreasing time without decreasing likely success).

Recommendation mapping component 164 illustratively maps the recommendations generated by recommendation engine 162 to action functionality. The action functionality is illustratively implemented by process update component 152 in business process configuration system 122. Therefore, a recommendation to improve a business process may be to add a stage to the process. Mapping component 164 maps that recommendation to functionality implemented by process update component 152. Therefore, when the user actuates a user input mechanism associated with that recommendation, process update component 152 will implement the functionality to add the identified stage to the identified process.

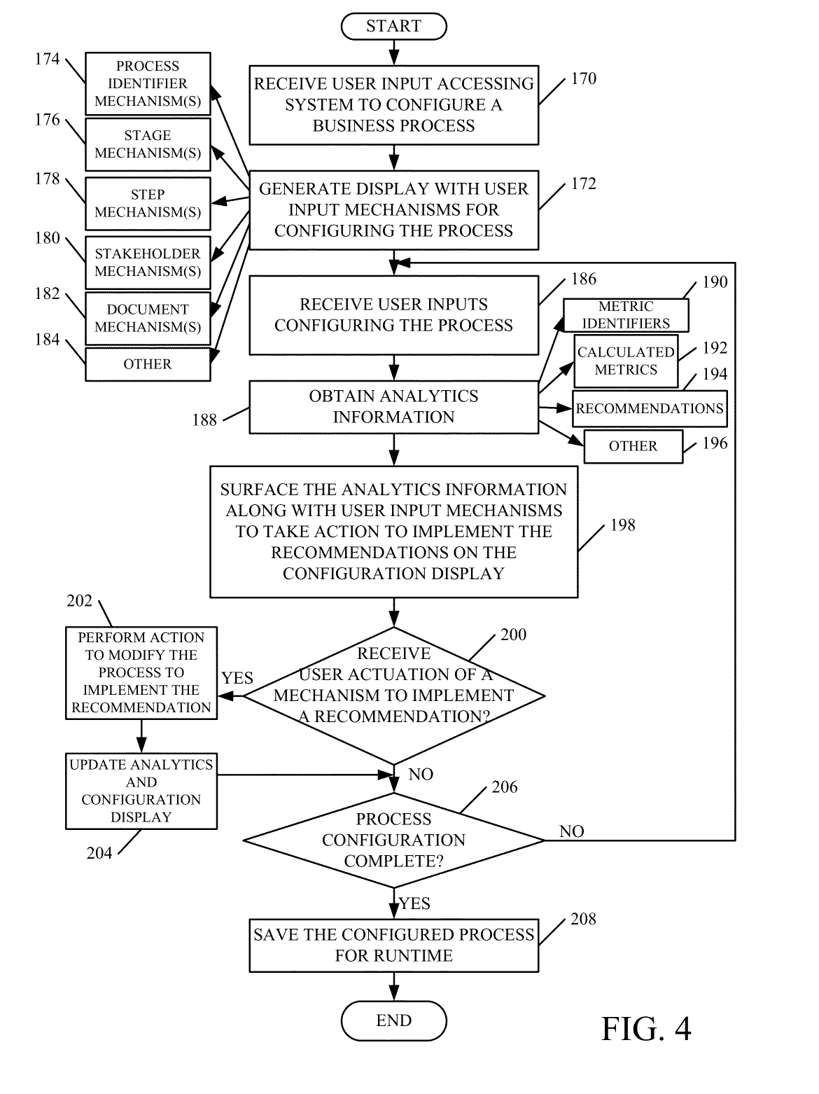

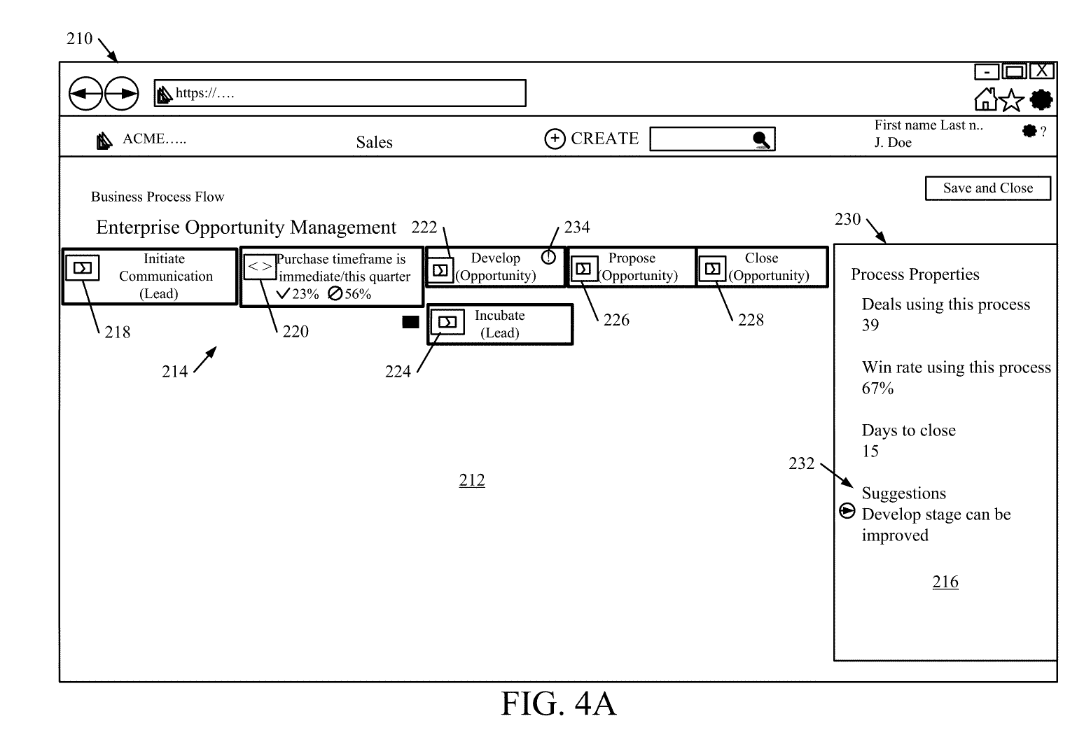

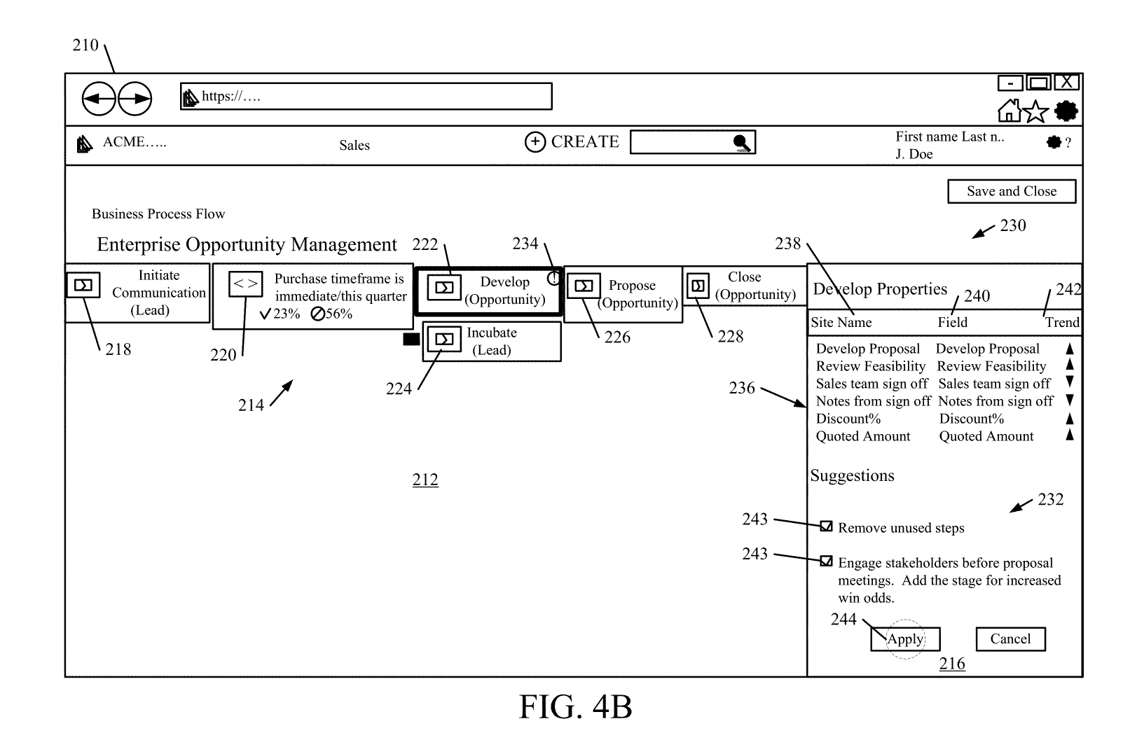

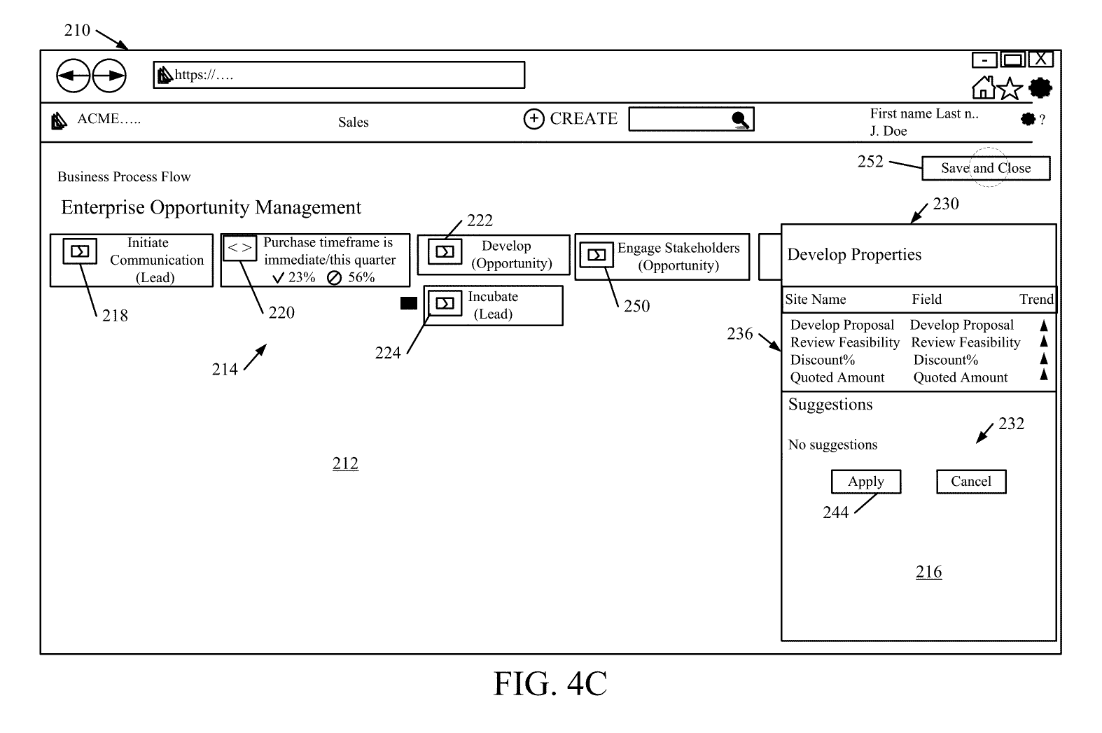

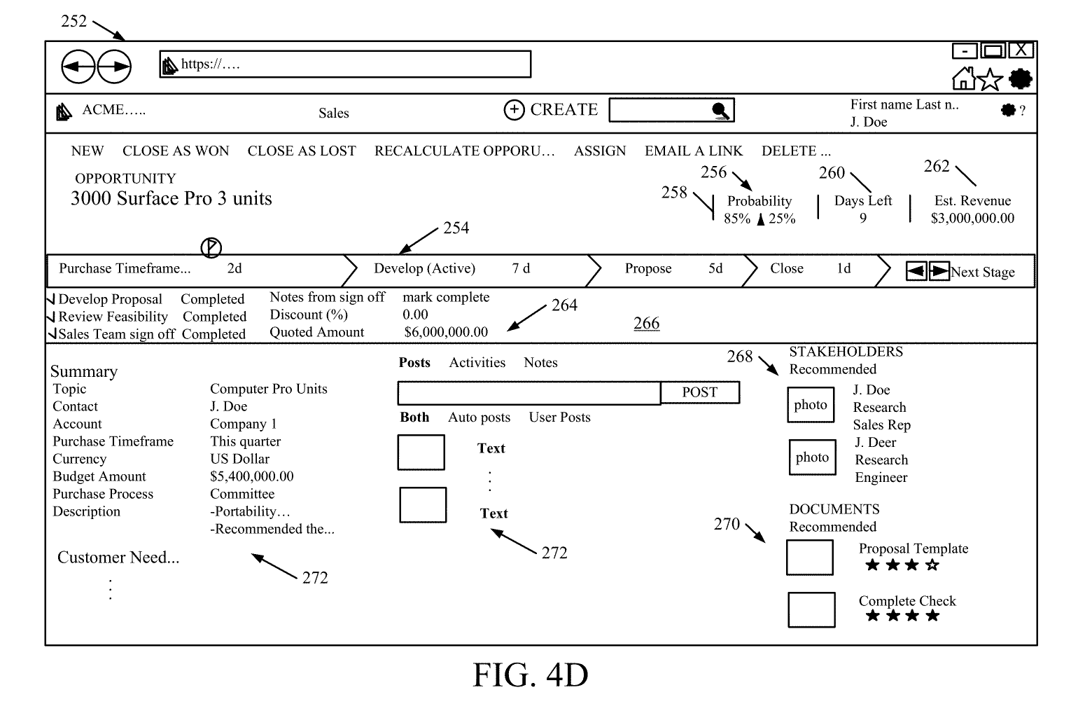

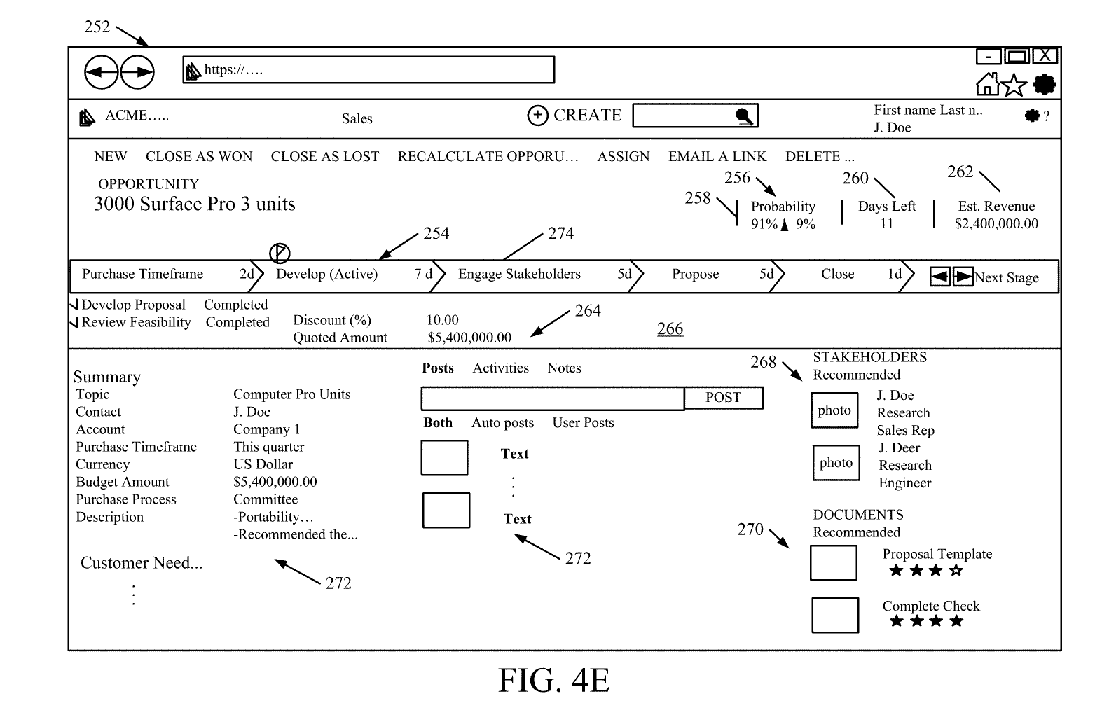

FIG. 4 is a flow diagram illustrating one example of the operation of business process configuration system 122 in facilitating the configuration of a business process by user 110. System 122 first receives a user input accessing system 122, in order to configure a business process. This is indicated by block 170 in FIG. 4. For instance, user 110 can provide an input identifying an already-existing business process 132 that the user wishes to modify. In another example, user 110 can provide an input indicating that the user wishes to configure a new business process 132.

System 122 then generates a configuration display with user input mechanisms for configuring the process. This is indicated by block 172. The user input mechanisms can include, for instance, a process identifier user input mechanism 174 that allows the user to input identifying information to identify the process being configured. It can include stage user input mechanisms 176 that allow a user to add and arrange stages in the process according to a desired order. It can include step user input mechanisms 178 that allow a user to add and arrange steps, within a given stage. It can include stake holder mechanisms 180 that can be actuated to add various different stake holders to the process, and it can include document input mechanisms 182 that allow a user to identify documents associated with the process. The user input mechanisms can include other mechanisms 184 as well, that can be actuated to allow a user to configure the process in other ways.

System 122 then receives user inputs configuring the process. This is indicated by block 186. For instance, the user can provide identification inputs so that process identifier component identifies the process. The user can provide stage configuration inputs so stage configuration component 144 configures the various stages within the process. The user can provide step configuration inputs so step configuration component 146 configures the various steps in the process. The user can provide stake holder and document inputs so that stake holder configuration component 148 associates various stake holders with the process, and document identifier component 150 associates various documents with the process.

When the process is configured, or during configuration of the process, system 122 accesses data analytics system 124. In one example, system 122 provides the configuration information indicating how the business process has been configured, thus far, to data analytics system 124. Data analytics system 124 then uses KPI identifier component 156 to identify various KPIs that can be calculated for the process being configured. KPI calculator component 158 can calculate values associated with the KPIs, based upon how the process is configured thus far, based upon historical data 138, based upon external data received from external systems 104, and based upon a wide variety of other information. Recommendation engine 164 also illustratively calculates recommendations for how the process being configured can be improved. Obtaining analytics information from data analytics system 124 is indicated by block 188 in the flow diagram of FIG. 4. Obtaining metric identifiers indicative of which metrics (e.g., KPIs) will be associated with the process is indicated by block 190. Obtaining calculated values for those metrics is indicated by block 192. Obtaining the recommendations is indicated by block 194. Data analytics system 124 can provide other analytic information as well, and this is indicated by block 196.

Once the analytics information is obtained, business process configuration system 122 surfaces the analytics information, along with user input mechanisms (that have been mapped to the recommendations by recommendation mapping component 164) that can be actuated to implement the recommendations. All of this information is illustratively displayed on a configuration display corresponding to the process being configured. This is indicated by block 198. The user can then actuate one of the user input mechanisms corresponding to any of the recommendations. This is indicated by block 200 in FIG. 4. When this occurs, process update component 152 in system 122 performs the actions that are mapped to that user input mechanism in order to modify the process to implement the corresponding recommendation. This is indicated by block 202.

It then updates the analytic information based on the modification to the process, and surfaces the updated information on the configuration display. This is indicated by block 204. By way of example, if the user takes a recommendation to modify the process by adding a step, this may increase the odds that the process will be successful. Therefore, data analytics system 124 recalculates the set of metrics associated with the process to obtain updated values, based upon the modification to the process being configured. It displays that information (the updated values) for the user.

This continues until the process configuration is complete. This is indicated by block 206. While the user is providing additional configuration inputs, processing reverts to block 186. However, when the process is fully configured, processing continues at block 208, where the configured process is saved for runtime operation in business system 102.

FIGS. 4A-4D show some examples of user interface displays that can be generated by business process configuration system 122 in order to allow a user to configure a business process, to display the analytics information, and to take recommendations that are suggested. FIG. 4A shows one example of a user interface display 210. User interface display 210 is one example of a business process configuration display that has a business process pane 212 that includes a set of display elements 214 that represent the process currently being configured. It also includes a properties pane 216 that displays a set of properties associated with the process being configured. In the example shown, pane 212 has display elements 214 that represent stages in a business process flow that entitled “Enterprise opportunity Management”. Display element 218 represents a stage entitled “Initiate Communication”. Display element 220 represents a stage entitled “Purchase Timeframe is Immediate/This Quarter . . . ”. Element 222 represents a “Develop” stage. Element 224 represents an “Incubate” stage. Element 226 represents a “Propose” stage and element 228 represents a “Close” stage.

During configuration, system 122 may provide the configuration information indicative of the process shown in FIG. 4A, to data analytics system 124. Data analytics system 124 illustratively calculates a set of process properties (or calculated metrics) 230 and they are displayed in pane 216. Those process properties are illustratively KPIs that are related to the open process displayed in pane 212. In the example shown in FIG. 4A, the KPIs (or calculated metrics) for the open process include a count of the number of deals in business system 102 that are currently using the process, a win rate (calculated in terms of percentage) where deals using the process were successfully completed, and an average number of days that it takes to close a deal using this particular process.

Data analytics system 124 also illustratively calculates a set of suggestions 232. In FIG. 4A, one suggestion 232 indicates that the develop stage (corresponding to display element 222) can be improved based upon the various data analytics that have been computed by system 124. FIG. 4A also shows and example in which the notification to optimize the “Develop” stage is also shown contextually on display element 222 (indicated by number 234) on the process pane 212. The suggestion display element 232 and the contextual indicator 234 are both illustratively actuatable elements. Therefore, when a user actuates either of them (such as by clicking on them with a point and click device, touching them on a touch sensitive display screen, etc.) business process configuration system 122 displays more details regarding how that particular stage can be improved.

FIG. 4B shows one example of user interface display 210 that indicates this. User interface display 210 is similar to that shown in FIG. 4A, and similar items are similarly numbered. However, it can be seen in FIG. 4B that the user has actuated either input mechanism 232 or input mechanism 234. Thus, business process configuration system 122 obtains the more detailed analytics information from system 124 and displays it in pane 216. Because the develop stage is now selected, properties section 230 now displays properties that are specific to the develop stage represented by display element 222, instead of the properties that relate to the process as a whole (as shown in FIG. 4A). Thus, properties section 230 now shows a list of steps 236 that are available in the develop stage. The list of steps 236 illustratively identifies a step name 238, a field value 240 for the step and a trend 242. Trend 242 is illustratively a KPI calculated by KPI calculator component 158 in system 124, and it indicates whether each of the steps 236 has historically been effective in successfully completing the process. In the example shown in FIG. 4B, the trend indicator 242 is an arrow. If the arrow is directed vertically upwardly, that indicates that the step has been effective. If it is directed downwardly, it indicates that the step has been ineffective. These are examples only.

The suggestions (or recommendations) section 232 now specifically shows suggestions for how to improve the develop stage (represented by the selected display element 222 in pane 212). The suggestions displayed in section 232, for the example shown in FIG. 4B, indicate that the two ineffective steps in the develop stage should be removed. A second recommendation is to add a stage in the process for engaging stake holders with the present process. In the example shown in FIG. 4B, this suggestion indicates that the stake holders should be engaged before the “Propose” stage. It also indicates that adding the new stage will increase the odds of winning a sale when executing this process.

FIG. 4B also shows that the suggestions in section 232 each have an individual selector element 243. Thus, the suggestions that the user desires to take can be selected using elements 243. FIG. 4B also shows that suggestions illustratively include an “Apply” user input mechanism 244. When the user actuates mechanism 244, process update component 152 in business process configuration system 122 illustratively follows the mapping generated by recommendation mapping component 164 for all of the selected suggestions (or recommendations) 232 and takes action to implement those recommendations. For instance, it automatically modifies the metadata corresponding to the process shown in FIG. 4B to remove the two ineffective steps (“Sales Team Signoff” and “Notes from Signoff”) from the develop stage. It also inserts a new stage in the process to engage stake holders.

When the user actuates the user input mechanism to take the suggestions, process update component 152 modifies the metadata to take the suggestions or recommendations and business process configuration system 122 modifies the process configuration display shown in user interface display 210 to indicate that the recommendations have been taken. FIG. 4C shows one example of this.

In FIG. 4C, some of the items are similar to those shown in FIGS. 4A and 4B, and they are similarly numbered. However, it can be seen that process update component 152 has now added a new stage referred to as “Engage Stage Holders” to the process, and represented the new stage by display element 250. This is because one of the recommendations was to add such a stage to the business process. The set of steps 236 displayed in properties section 230 also shows that the two ineffective steps were removed in order to further streamline the process. Because both suggestions were taken, suggestions section 232 indicates that there are no further suggestions for the business process being configured. Thus, the process has been automatically modified based on user actuation of the user input mechanisms indicating that the user wishes to take one of the recommendations or suggestions.

Once the process is configured, the user 110 can save it for runtime use by the business system 102. In the example shown in FIG. 4C, a user input mechanism 252 is actuated by the user to save the configured business process.

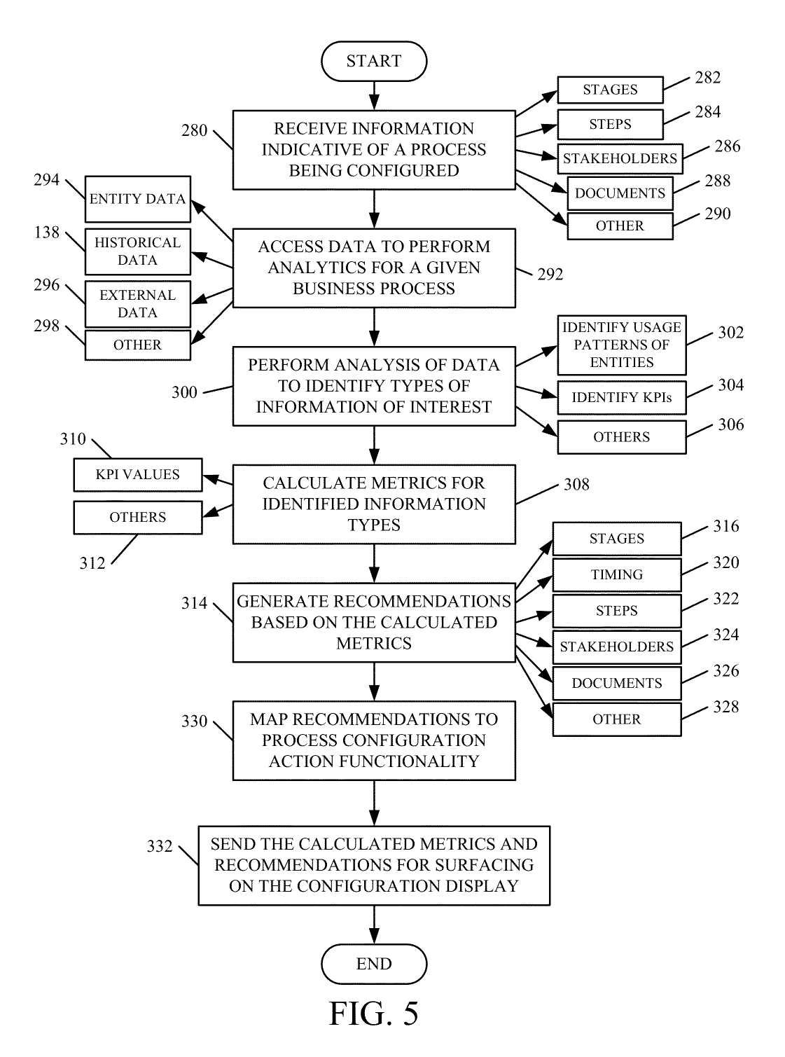

While runtime operation is discussed in more detail below with respect to FIGS. 6-7, FIGS. 4D and 4E show examples of how the process user interface display that a user sees during runtime of the process will change based upon the recommendations that were implemented as discussed above with respect to FIGS. 4A-4C. FIG. 4D shows one example of a process user interface display 252. Process user interface display 252 illustratively includes a stages display 254 that shows the different stages in the corresponding process. It also illustratively includes a set of calculated KPIs or metrics 256 that are calculated by data analytics system 124, corresponding to the runtime process. These are described in greater detail below with respect to FIGS. 5-7. Briefly, however, they include a probability metric 258 that indicates a probability that the process will be successfully completed. They include an estimated days left metric 260 that includes an estimation of the number of days that are likely left to complete the process, and it includes an estimated revenue metric 262 that identifies an estimated revenue for the process, if it is successfully completed.

FIG. 4D shows that the active stage in the process is the “Develop” stage. Thus, the application system 118 displays the steps 264 for the “Develop” stage in a step display section 266. In the example shown in FIG. 4D, display 252 also includes a stake holder display section 268 that shows stake holders corresponding to this process, and a documents display section 270 that displays links to documents that are associated with this process. It also includes additional detail display sections 272 that display additional details regarding the process. Display 252 is generated prior to the user taking any of the recommendations discussed above. Therefore, it can be seen that the stage display section 254 does not include the stage for engaging stake holders. Also, the steps 264 include the two ineffective steps “Sales Team Signoff” and “Notes from Signoff”.

However, after the user actuates the user input mechanisms to take the suggestions or recommendations generated by data analytics system 124, process update component 152 automatically modifies the process to take those suggestions. Therefore, as discussed above, it will insert a stage to engage stake holders, and it will eliminate the two ineffective steps from the develop stage. In one example, this will automatically be reflected on the process display 252. FIG. 4E shows one example of this. The stage display section 254 shows that the stage 274 for engaging the stake holders has automatically been added. In addition, the steps display section 266 shows that the set of steps 264 no longer includes the two steps that were identified as being ineffective. It can also be seen that the metrics 256 have been updated as well. It can be seen that the probability metric 258 is increased and the days left metric 260 is also increased to reflect the changes to the underlying business process.

FIG. 5 is a flow diagram illustrating one example of how data analytics system 124 identifies and calculates values for KPIs, and generates recommendations, during configuration of a business process. Data analytics system 124 first receives information indicative of a process being configured. This is indicated by block 280 in FIG. 5. This can include stage information 282 that identifies the various stages in the process. It can include step information 284 that identifies the steps in each stage. It can include stake holder identifying metadata 286 that identifies stake holders and document identifier metadata 288 that identifies documents associated with the process. It can include other metadata or other information 290 indicative of other information regarding the configured process.

System 124 then access data that it uses to perform analytics for the given business process. This is indicated by block 292. The data can include, for instance, entity data 294 regarding entities 128 in business data store 114. This information can be related to the entities that form the basis of each stage in the business process, or it can be for related entities as well. It can also access historical data 138 that identifies how successful this or similar business processes have been in the past, or other historical information. This can include information that is used to identify usage patterns of various entities in the system as well. Data analytics system 124 can obtain external data 296 from external data systems 104. This can include a wide variety of other business analytics information that can be used to perform analysis. It can obtain other information 298, also.

KPI identifier component 156 then performs analysis on the data to identify different types of information of interest (such as information that can be reflected in various KPIs). This is indicated by block 300. For instance, the analysis can identify usage patterns of the various entities in business data store 114. This is indicated by block 302. It can identify the particular KPIs that may be useful for a user of this type of business process. This is indicated by block 304. It can identify other types of information of interest as well, and this is indicated by block 306.

KPI calculator component 158 then calculates values or metrics for the identified KPIs. This is indicated by block 308. As mentioned, this can be reflected as KPI values 310, or in other ways 312.

Recommendation engine 162 then generates recommendations based upon the calculated metrics. This is indicated by block 314. For instance, recommendation engine 162 can recommend to add, eliminate, or reorder various stages in the process. This is indicated by block 316. It can recommend changing the timing associated with individual stages or the process as a whole. This is indicated by block 320. It can recommend changes to the steps corresponding to any given stage, and this is indicated by block 322. It can recommend changes to the stake holders (such as by adding stake holder, deleting stake holders, recommending certain individuals as being best stake holders for the process, etc.). This is indicated by block 324. It can recommend that certain documents be associated with this process, or eliminated from the process. This is indicated by block 326. It can generate a variety of other recommendations as well, and this is indicated by block 328.

Recommendation mapping component 164 then maps the recommendations to process configuration action functionality that can be implemented to take the recommendations and apply them to the given business process. This is indicated by block 330. For instance, if a recommendation is to add a stage, this can be mapped, using an actuatable user input mechanism, to corresponding functionality, so process update component 152 will automatically add the stage when the user input mechanism is actuated. This can be done in other ways as well.

Data analytics system 124 then sends the calculated metrics and recommendations for surfacing on the configuration display generated by business process configuration system 122. This is indicated by block 332 and a number of examples of this were shown above with respect to FIGS. 4A-4C.

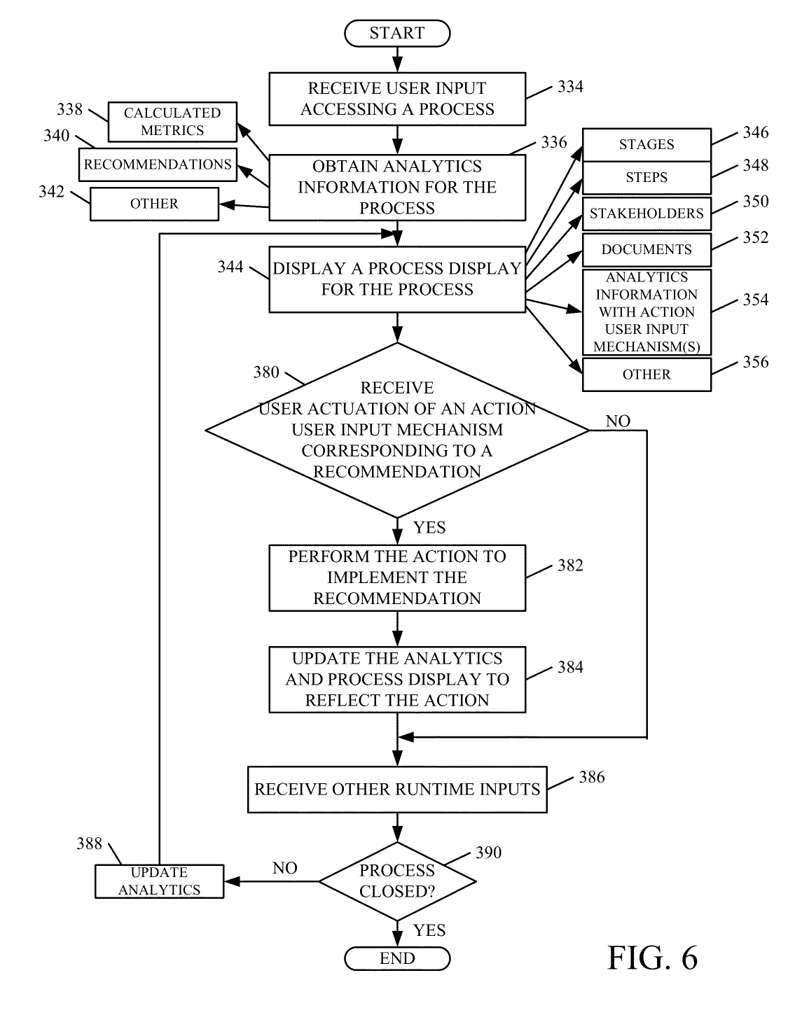

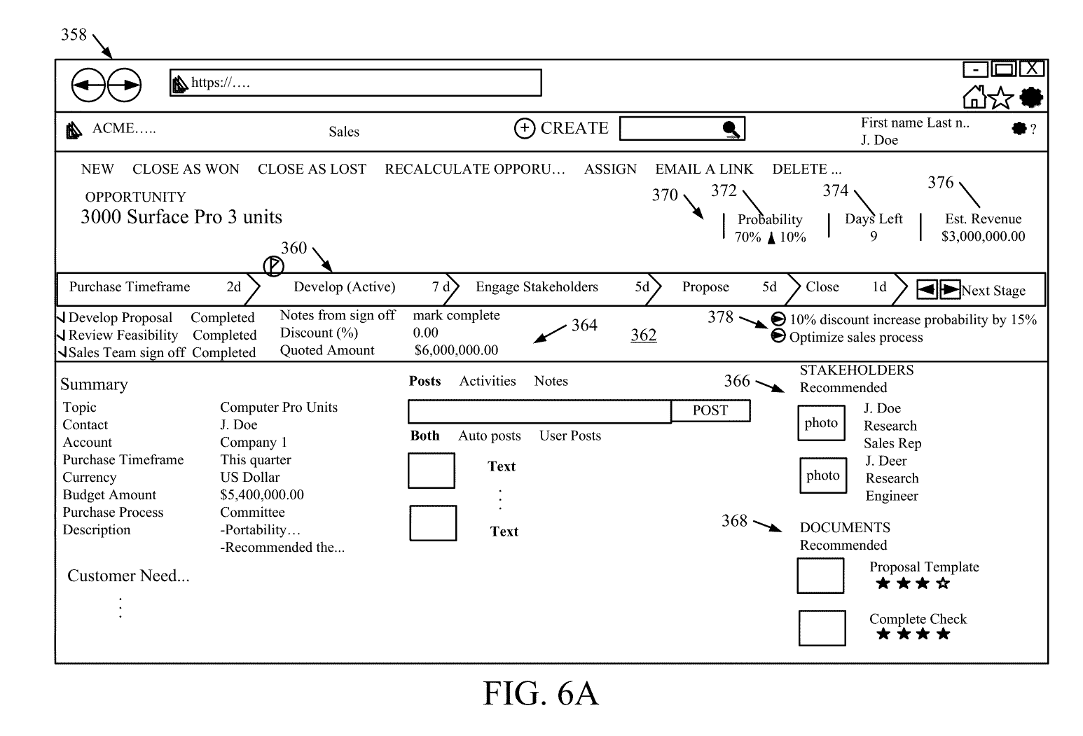

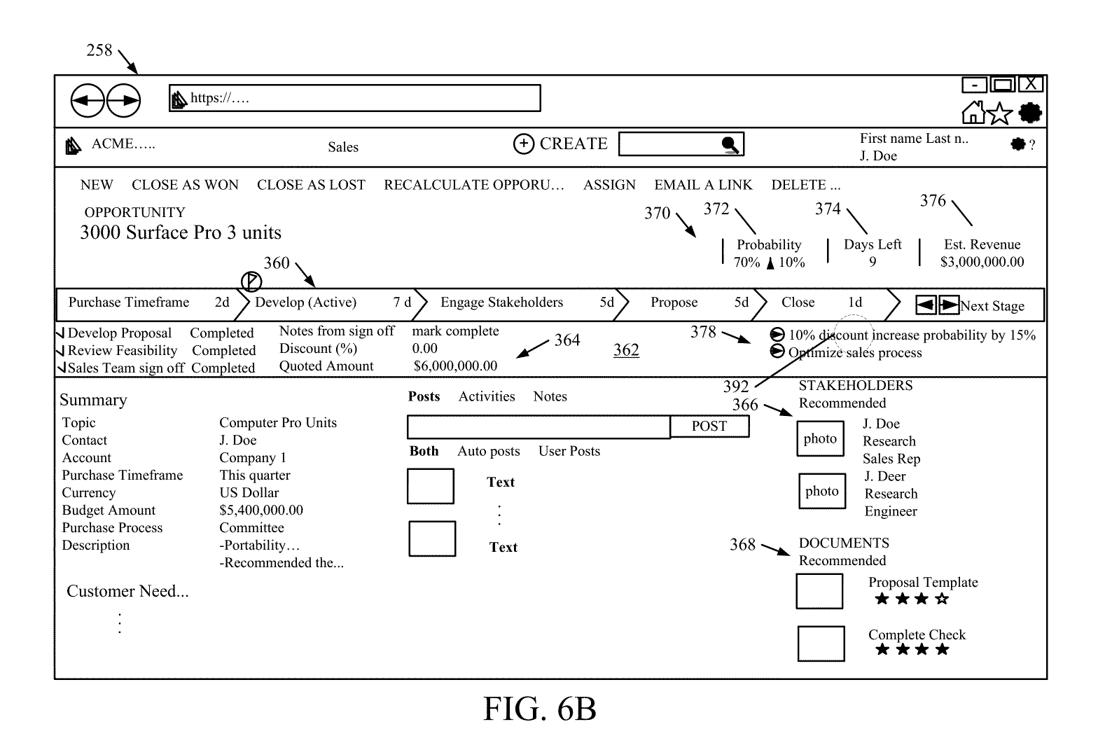

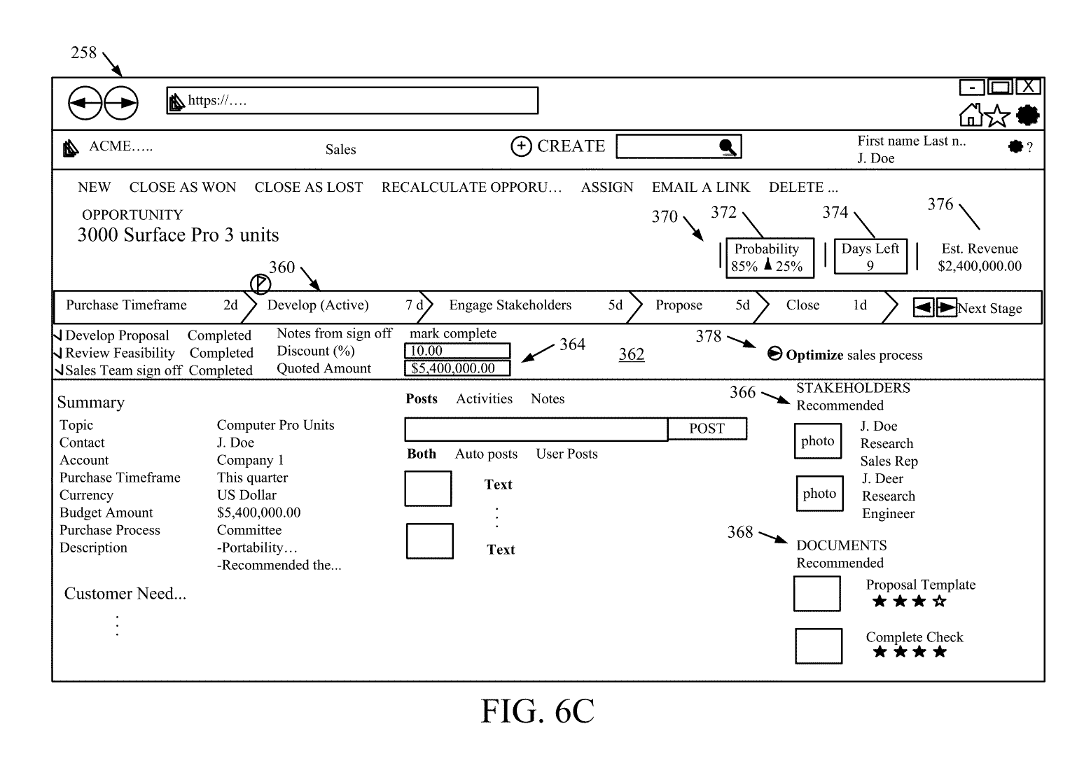

FIG. 6 is a flow diagram illustrating one example of the operation of application system 118 in using data analytics system 124 during runtime operation of a given process. FIGS. 6A-6C show examples of user interface displays that indicate this as well.

Application system 118 first receives user input accessing a given process. This is indicated by block 334 in FIG. 6. By way of example, user 110 may log onto business system 102 and provide inputs indicating that the user wishes to launch or otherwise access a sales process within business system 102.

Business analytics accessing component 120 then provides information indicative of the process being accessed (such as configuration information, state information, etc.) to data analytics system 124 to obtain analytics information for the requested process. This is indicated by block 336. System 124 illustratively returns the calculated metrics or KPIs as indicated by block 338. It can illustratively return recommendations as indicated by block 340 and other analytics information 342.

Application system 118 then displays a process display for the opened process. This is indicated by block 344. The process display can include a stages display 346, that displays the various stages in the process. It can include a steps display 348 that displays the steps within an active stage. It can include a stake holders display 350 that identifies stake holders for the process. It can include a documents display 352 that identifies documents associated with the process, and it can include analytics information with action user input mechanisms as indicated by block 354, that can be actuated by the user to take action with respect to the analytics information. It can include other displayed information 356 as well.

FIG. 6A shows one example of a process display 358 that is generated when the user accesses a given process. It can be seen in the example shown in FIG. 6A that the user has accessed a process entitled “3000 Surface Pro three units”. A stages display mechanism 360 shows that the process includes four stages. It includes a “Qualify” stage, a “Develop” stage, a “Propose” stage, and a “Close” stage. Each stage has a time indicator indicating an estimated number of days (calculated by system 124) that a user should spend in each stage. FIG. 6A also shows that the “Develop” stage is the currently active stage and that the recommended amount of time to spend on this stage is 7 days.

Display 358 also includes a step display section 362 that displays a set of steps 364 corresponding to the active stage (the “Develop” stage). Display 358 includes a stake holders display 366 that shows stake holders that are currently recommended for the process and a documents display section 368 that shows documents that are recommended for the process.

In addition, display 358 illustratively shows a KPI display section 370. KPI display section 370, shows KPIs that have been identified as being relevant for this process, and each includes a value or measure that has been calculated for the corresponding KPI. For instance, probability display 372 displays a KPI that is indicative of the probability of closing the deal represented by this process. The data analytics system 124 automatically computes the probability and application system 118 automatically surfaces it, in context, for viewing by the user. The metrics display section 370 also includes a days left metric 374 and an estimated revenue metric 376. Each of these metrics are automatically calculated and surfaced for the user, in context, as well.

Display 358 also illustratively includes a recommendations display section 378. It can be seen in the example shown in FIG. 6A that display section 378 includes a first recommendation that indicates that a 10% discount will increase the probability of closing the deal by 15%. It also includes a recommendation for optimizing the sales process. The recommendation to provide a discount in order to increase the probability of successfully closing the deal can be based on a wide variety of different types of information. For instance, it can include historical data collected from past deals of all customers, or from past deals with the present customer only, or both. It can include historical data for customers only in this type of industry, and it can include data indicative of the cost of past deals and historical and social information about the primary contact and other information that data analytics system has access to.

In addition, based on historical data 138, data analytics system 124 has automatically calculated user ratings of various documents, and identifies the highest ranking documents for the present process. It also identifies key stake holders, as stake holders that have been most heavily involved in successful processes of this type. It thus recommends stake holders and documents that will help to close the present deal.

Each of the recommendations (those in recommendation section 378 as well as the recommended stake holders in section 366 and the recommended documents in section 368) are illustratively displayed along with an actuatable display element. These display elements are illustratively mapped to action functionality by recommendation mapping component 164. Therefore, even during runtime, when a user 110 actuates one of those user input mechanisms, the associated functionality in business process configuration system 122 automatically takes the actions to reconfigure the business process in order to take the associated recommendation. For instance, when the user actuates a user input mechanism associated with a recommended document, configuration system 122 automatically reconfigures the process so that it has a displayed link to the identified document.

Once the system has generated this display, then the user can take a wide variety of different types of actions. For instance, the user can actuate one of the user input mechanisms corresponding to a recommendation. This is indicated by block 380 in the flow diagram of FIG. 6. When the user does this, then process configuration system 122 illustratively performs the action to implement the recommendation. This is indicated by block 382. The business analytics accessing component 120 then accesses the data analytics system 124 to obtain updated analytics based upon modifications to the process made in order to take the recommendation. This is indicated by block 384. The user can also continue to provide other business process inputs to execute the runtime process. This is indicated by block 386. As the user makes changes to the process or continues to execute the process, the analytics are updated as indicated by block 388. This continues until the process is closed, as indicated by block 390.

FIGS. 6B-6C show examples of two different user interface displays that indicate how a user can implement recommendations. FIG. 6B is similar to FIG. 6A, and similar items are correspondingly numbered. However, it can be seen in FIG. 6B that the user is actuating the recommendation in section 370 that suggests that the user provide a 10% discount in order to increase the probability of closing the deal. The user selecting this recommendation is indicated by the dashed circle 392.

When the user does this, application system 118 automatically accesses business process configuration system 122, and process update component 152 automatically takes the actions mapped to that user input mechanism to modify the process. Data analytics system 124 then updates the corresponding metrics that are affected by the recommendation, and the modified process (along with the updated analytics) are displayed to the user.

FIG. 6C shows one example of user interface display 258 that indicates this. It can be seen in FIG. 6C that a number of the items are similar to those shown in FIG. 6B, and they are similarly numbered. However, FIG. 6C shows that the list of steps 364 in step display section 362 has now been modified. It can be seen that the “discount” step has been modified from displaying 0 (in FIG. 6B) to displaying 10% (in FIG. 6C). Also, because a discount has been applied, the quoted amount step in step display section 362 has been reduced from $6,000,000.00 (in FIG. 6B) to $5,400,000.00 (in FIG. 6C), reflecting the 10% discount. It can also be seen that the calculated metrics in section 370 have been updated as well. The probability metric 372 has been increased from 70% (in FIG. 6B) to 85% (in FIG. 6C), reflecting the increase in probability associated with revising the process to apply a 10% discount. In addition, the estimated revenue metric 376 has been decreased from $3,000,000.00 (shown in FIG. 6B) to $2,400,000.00 (shown in FIG. 6C), to reflect the affect on revenue of the 10% reduction in the quoted sales amount.

FIG. 6C also shows that the recommendation section 378 has been modified. It no longer has the recommendation associated with applying a discount. It still does include, however, the recommendation associated with updating the entire sales process that was calculated based on the historical information and the success/failure of various steps and stages in closing the deal. If the user actuates this user input mechanism, the user will illustratively be automatically navigated to a user interface display where the user can choose to modify the sales process (such as the user interface displays discussed above with respect to FIGS. 4A-4C).

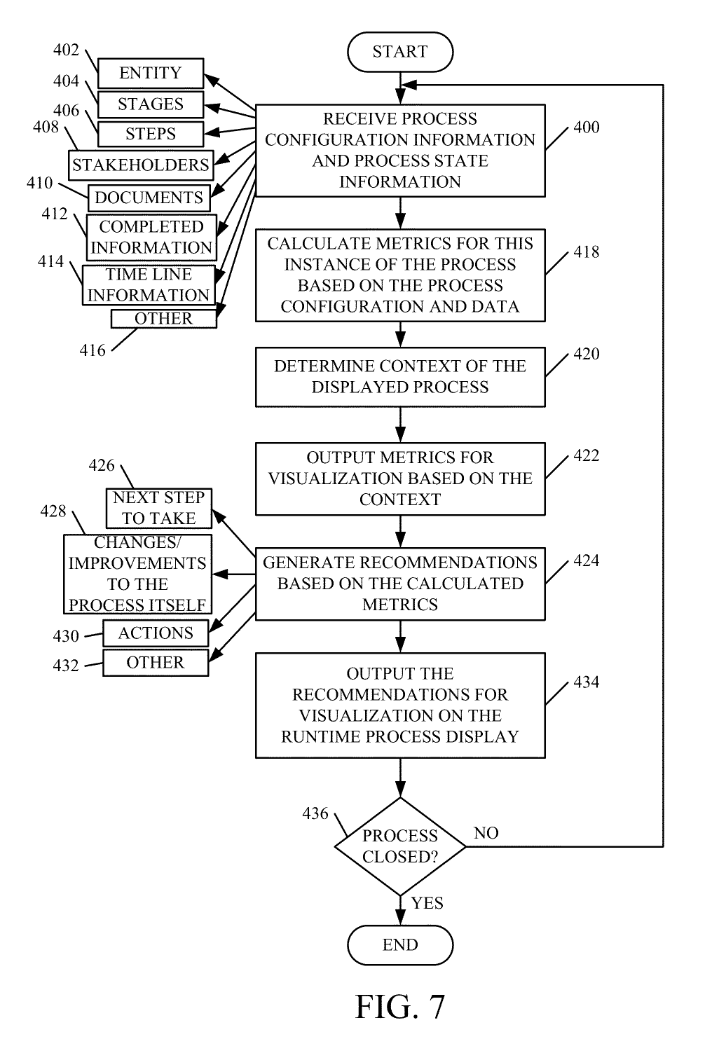

FIG. 7 is a flow diagram illustrating one example of the operation of data analytics system 124 in calculating analytics, during runtime, for a business process. At some point during the runtime operation, business analytics accessing component 120 in application system 118 provides the process configuration information and process state information to data analytics system 124. This is indicated by block 400 in FIG. 7. This information can include entity information 402 that identifies the various entities associated with the process. It can include stage information 404 that identifies the various stages, and step information 406 that identifies the steps corresponding to each stage. It can include stake holder information 408 that identifies current stake holders in the process and document information 410 that identifies current documents associated with the process. It can include completed information 412 that indicates which steps and stages have been completed in the process, and it can include timeline information 414 that identifies the various timelines associated with the stages and steps in the process. Of course, it can include other information 416 as well.

Data analytics system 124 then calculates (for this instance of the process) the metrics based upon the process configuration information and the state information, and other data. This is indicated by block 418 in FIG. 7. In one example, system 124 also determines a current context of the displayed process as indicated by block 420, and outputs only the metrics that are to be visualized in that context. This is indicated by block 422. In another example, the data analytics system 124 can provide all analytical information to application system 118, and application system 118 can, itself, determine which metrics to visualize in the various contexts of the business process.

In any case, data analytics system 124 also illustratively generates recommendations based upon the calculated metrics. This is indicated by block 424. For instance, the recommendations can indicate a next step that should be taken in order to perform the process. This is indicated by block 426. It can include changes or improvements to the process itself, as indicated by block 428. It can include a variety of different types of actions as indicated by block 430, and it can include other recommendations as well, as indicated by block 432.

Data analytics system 124 then outputs the recommendations for visualization on the runtime process display. This is indicated by block 434. Processing can continue in this way, with data analytics system 124 providing updated analytics and recommendations as the user and/or business system carry out the process. It can also provide updated analytics as the user takes recommendations or performs recommended steps. At some point, the process will be closed. This is indicated by block 436.

It can thus be seen that the business system performance is enhanced, as is the user experience, by using data analytics to surface key performance indicators. For instance, information stored in the business system for various entities can be analyzed to identify usage patterns. This information, and other information, can be used to compute KPIs. These calculated values are then surfaced in appropriate places (or contexts) in the business process. Trend analysis across multiple data sets can be performed and suggestions for next logical or next best steps to take can be provided to users in the business process. Actions that users can take can also be provided, and users can be presented with actions (such as user input mechanisms) that can be actuated to automatically apply the settings or suggestions inside the process. Recommendations can be generated and surfaced for indicating how to improve or customize the process, and such recommendations can also be provided in actionable form (such as by providing associated user input mechanisms that can be actuated to apply the recommendations). These things provide significant technical advantages. They greatly improve the performance of the business system, itself. By more quickly and accurately surfacing relevant information for the user, the user need not perform various searches and retrieval operations within the system, in order to identify this information. This reduces unneeded computing overhead within the system, thus increasing its performance. It also significantly enhances the user's experience and allows the user to greatly increase productivity. The system automatically (without further user involvement except, perhaps, to initiate the customization) customizes the business process in order to improve the process itself. This reduces user interactions with the system to reconfigure the process. Thus, the system need not present all of the user interfaces normally needed to reconfigure a business process. By automatically reconfiguring the process itself, this reduces the amount of time needed for a user to configure the process, and it also reduces the computing overhead for the system, because the user need not navigate to the configuration system, invoke all of the processing steps needed to modify the system, and then resave the process.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

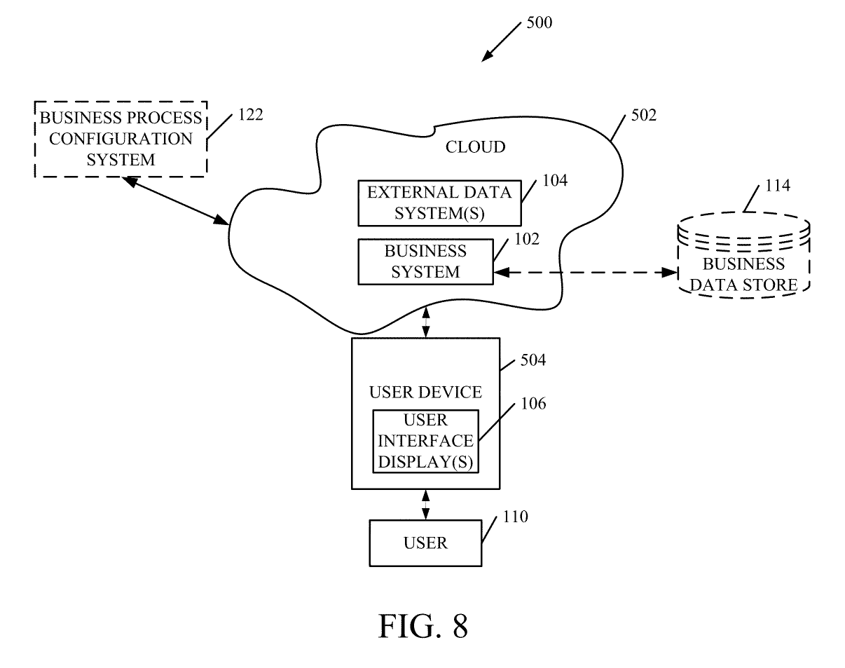

FIG. 8 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 8, some items are similar to those shown in FIG. 1 and they are similarly numbered. FIG. 8 specifically shows that business system 102 is located in cloud 502 (which can be public, private, or a combination where portions are public while others are private). Therefore, user 110 uses a user device 504 to access those systems through cloud 502.

FIG. 8 also depicts another example of a cloud architecture. FIG. 8 shows that it is also contemplated that some elements of business system 102 can be disposed in cloud 502 while others are not. By way of example, data store 114 can be disposed outside of cloud 502, and accessed through cloud 502. In another example, business process configuration system 122 can also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

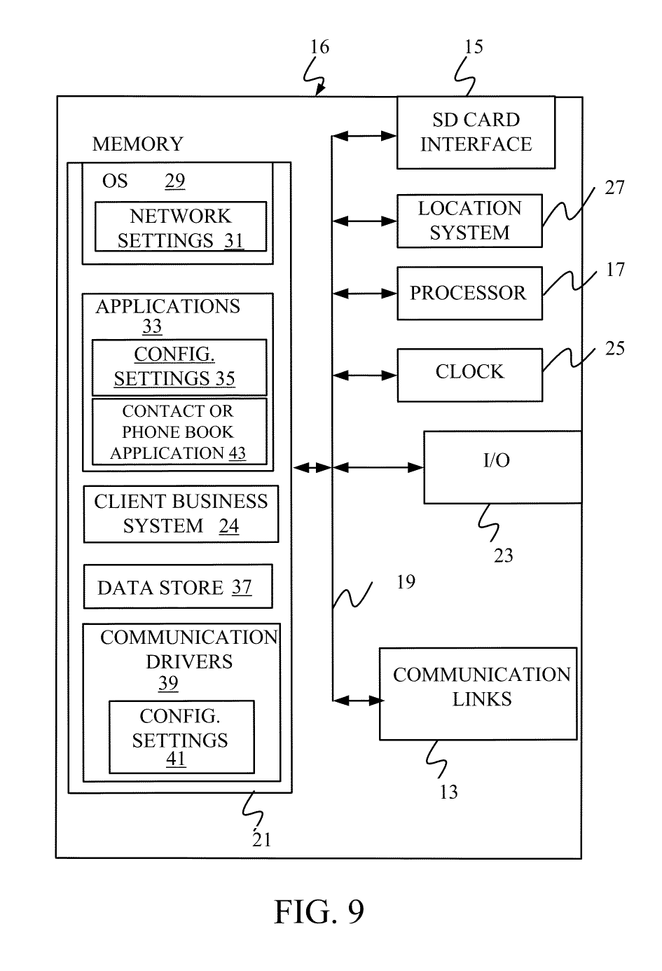

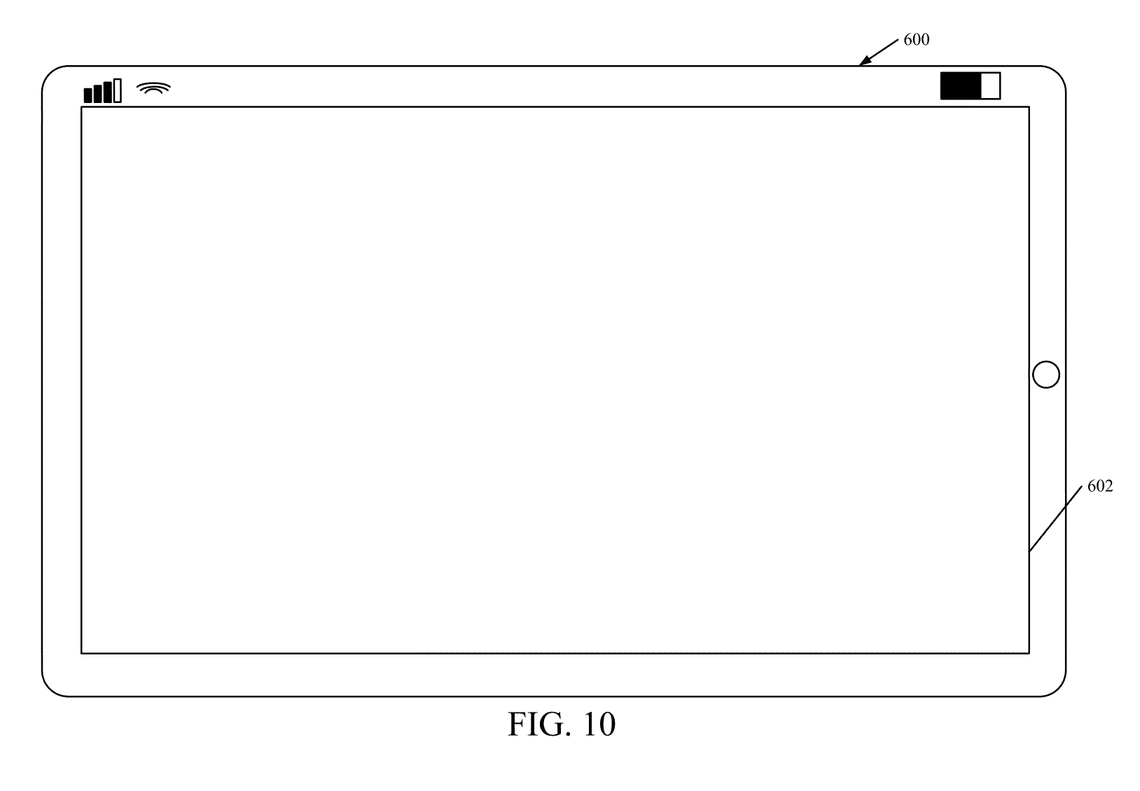

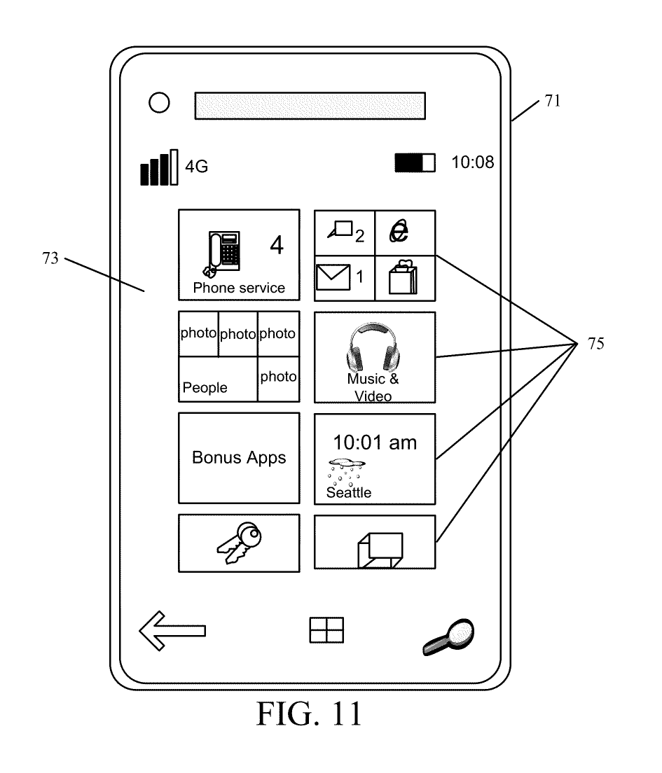

FIG. 9 is a simplified block diagram of one illustrative embodiment of a handheld or mobile computing device that can be used as a user's or client's hand held device 16, in which the present system (or parts of it) can be deployed. FIGS. 10-11 are examples of handheld or mobile devices.

FIG. 9 provides a general block diagram of the components of a client device 16 that can run components of business system 102 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor 112 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of business system 102. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 10 shows one embodiment in which device 16 is a tablet computer 600. In FIG. 10, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used as well. Device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1×rtt, and Short Message Service (SMS) signals. In some embodiments, the phone also includes a Secure Digital (SD) card slot that accepts a SD card.

The mobile device can also be is a personal digital assistant (PDA) or a multimedia player or a tablet computing device, etc. (hereinafter referred to as PDA). The PDA can include an inductive screen that senses the position of a stylus (or other pointers, such as a user's finger) when the stylus is positioned over the screen. This allows the user to select, highlight, and move items on the screen as well as draw and write. The PDA also includes a number of user input keys or buttons which allow the user to scroll through menu options or other display options which are displayed on the display, and allow the user to change applications or select user input functions, without contacting the display. The PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. FIG. 11 is an example where the device is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

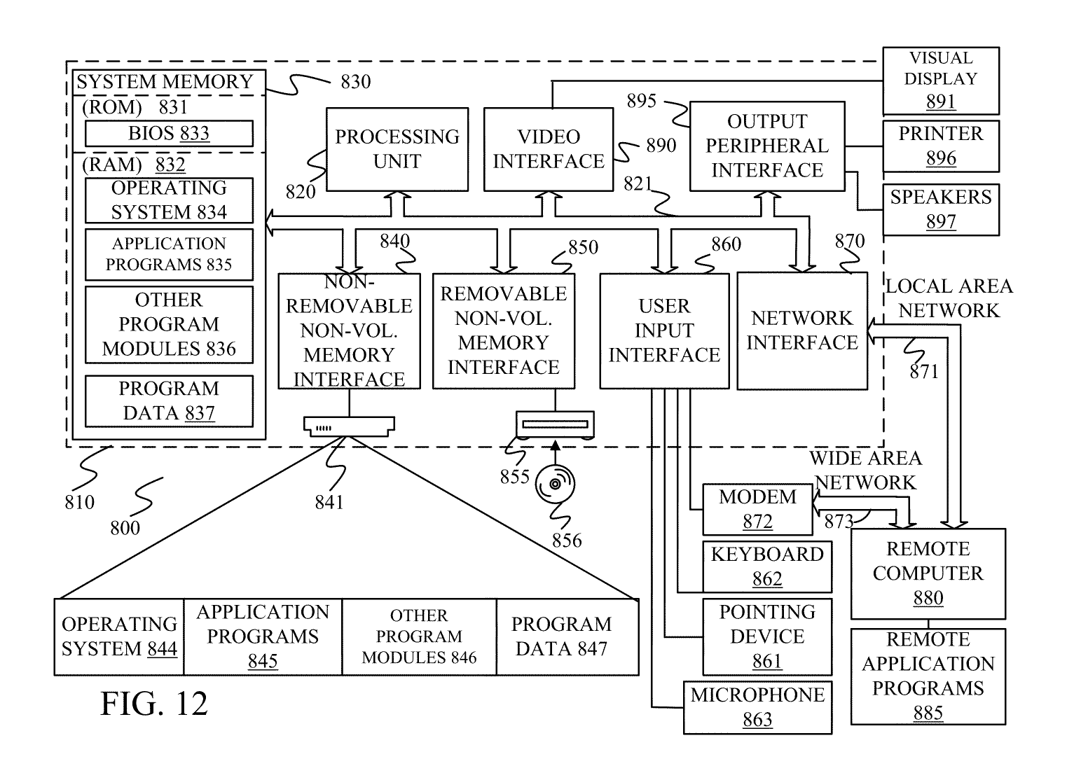

FIG. 12 is one embodiment of a computing environment in which architecture 100, or parts of it, (for example) can be deployed. With reference to FIG. 12, an exemplary system for implementing some embodiments includes a general-purpose computing device in the form of a computer 810. Components of computer 810 may include, but are not limited to, a processing unit 820 (which can comprise processor 112), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 12.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 12 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 12 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a process configuration system that includes a set of configuration components that generate a process configuration display that includes process configuration user input mechanisms, the process configuration system configuring a process based on user actuation of the process configuration user input mechanisms, the process configuration system obtaining analytics information indicative of recommendations to modify the process and generating recommendation user input mechanisms corresponding to the recommendations;

a process update component that modifies the process to take the recommendations based on user actuation of the recommendation user input mechanisms; and

a user interface component that displays the process configuration display with the process configuration user input mechanisms and the recommendation user input mechanisms.

Example 2 is the computing system of any or all previous examples wherein the process configuration system comprises a business process configuration system and wherein the process comprises a business process.

Example 2 is the computing system of any or all previous examples wherein the analytics information includes performance metric values for performance metrics corresponding to the business process, the performance metrics being indicative of performance of the business process.

Example 4 is the computing system of any or all previous examples wherein the business process configuration system generates the process configuration display to display the performance metric values for the performance metrics.

Example 5 is the computing system of any or all previous examples wherein the set of configuration components comprises:

a stage configuration component that generates stage configuration user input mechanisms that are actuatable to configure stages in the business process;

Example 6 is the computing system of any or all previous examples wherein the set of configuration components comprises:

a step configuration component that generates step configuration user input mechanisms that are actuatable to configure steps within the stages in the business process.

Example 7 is the computing system of any or all previous examples wherein the process configuration system generates the recommendation user input mechanisms corresponding to recommendations comprising recommendations to modify a set of stages or a set of steps in the business process, the process update component modifying the set of stages or the set of steps based on user actuation of the corresponding recommendation user input mechanism.

Example 8 is the computing system of any or all previous examples wherein the process configuration system obtains and displays, on the process configuration display, updated performance metric values for the performance metrics based on modifications to the set of stages or the set of steps.

Example 9 is the computing system of any or all previous examples wherein the set of configuration components comprises:

a stake holder configuration component that generates stake holder configuration user input mechanisms that are actuatable to configure stake holders for the business process.

Example 10 is the computing system of any or all previous examples wherein the set of configuration components comprises:

a document configuration component that generates document configuration user input mechanisms that are actuatable to configure documents associated with the business process.

Example 11 is the computing system of any or all previous examples wherein the process configuration system generates the recommendation user input mechanisms corresponding to recommendations comprising recommendations to modify the stake holders for, or the documents associated with, the business process, the process update component modifying the stake holders or the documents based on user actuation of the corresponding recommendation user input mechanism.

Example 12 is the computing system of any or all previous examples wherein the performance metric comprise a success metric indicative of a likely success of the business process, the process configuration component generating the process configuration display to display the success metric.

Example 13 is the computing system of any or all previous examples wherein the performance metrics comprise a timeliness metric indicative of a length of time likely used to complete the business process, the process configuration component, the process configuration component generating the process configuration display to display the timeliness metric.

Example 14 is a computing system, comprising:

an application system that runs an application to implement a running process and that generates a process display indicative of the running process;

an analytics accessing component that obtains analytics information, comprising metric information indicative of values for performance metrics for the running process, based on a configuration and state of the running process; and

a user interface component that displays the process display with the analytics information.

Example 15 is the computing system of any or all previous examples wherein the running process comprises a business process in a business system and wherein the metric information comprises key performance indicator values for a set of key performance indicators corresponding to the business process.

Example 16 is the computing system of any or all previous examples and further comprising:

a contextual surfacing component that surfaces the key performance indicators on the process display based on a context of the process display relative to the business process.

Example 17 is the computing system of any or all previous examples wherein the analytics information comprises recommendations to modify the running process, the application system generating recommendation user input mechanisms corresponding to the recommendations on the process display.

Example 18 The computing system of any or all previous examples and further comprising:

a process update component that modifies the running process based on user actuation of the recommendation user input mechanisms, the application system updating the process display to reflect modifications made to the running process.

Example 19 is the computing system of any or all previous examples wherein the analytics accessing system accesses updated analytics information based on the modifications to the running process.

Example 20 is a method, comprising:

displaying a process display indicative of a structure of a process run in a computer system;

obtaining performance metric values for a set of performance metrics for the process;

obtaining a set of suggestions for modifying the process based on the performance metric values;

displaying the performance metric values for the performance metrics on the process display;

displaying user actuatable input mechanisms corresponding to the suggestions;

receiving user actuation of a given user actuatable input mechanism;

automatically taking action to modify the process based on the suggestion; and

updating the process display and the performance metric values based on the modification.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a process configuration system that includes a set of configuration components that generate a process configuration display that includes process configuration user input mechanisms, the process configuration system configuring a process based on user actuation of the process configuration user input mechanisms, the process configuration system obtaining analytics information indicative of recommendations to modify the process and generating recommendation user input mechanisms corresponding to the recommendations;
a process update component that modifies the process to take the recommendations based on user actuation of the recommendation user input mechanisms; and
a user interface component that displays the process configuration display with the process configuration user input mechanisms and the recommendation user input mechanisms.

2. The computing system of claim 1 wherein the process configuration system comprises a business process configuration system and wherein the process comprises a business process.

3. The computing system of claim 2 wherein the analytics information includes performance metric values for performance metrics corresponding to the business process, the performance metrics being indicative of performance of the business process.

4. The computing system of claim 3 wherein the business process configuration system generates the process configuration display to display the performance metric values for the performance metrics.

5. The computing system of claim 4 wherein the set of configuration components comprises:
a stage configuration component that generates stage configuration user input mechanisms that are actuatable to configure stages in the business process;

6. The computing system of claim 5 wherein the set of configuration components comprises:
a step configuration component that generates step configuration user input mechanisms that are actuatable to configure steps within the stages in the business process.

7. The computing system of claim 6 wherein the process configuration system generates the recommendation user input mechanisms corresponding to recommendations comprising recommendations to modify a set of stages or a set of steps in the business process, the process update component modifying the set of stages or the set of steps based on user actuation of the corresponding recommendation user input mechanism.

8. The computing system of claim 7 wherein the process configuration system obtains and displays, on the process configuration display, updated performance metric values for the performance metrics based on modifications to the set of stages or the set of steps.

9. The computing system of claim 4 wherein the set of configuration components comprises:
a stake holder configuration component that generates stake holder configuration user input mechanisms that are actuatable to configure stake holders for the business process.

10. The computing system of claim 9 wherein the set of configuration components comprises:
a document configuration component that generates document configuration user input mechanisms that are actuatable to configure documents associated with the business process.

11. The computing system of claim 10 wherein the process configuration system generates the recommendation user input mechanisms corresponding to recommendations comprising recommendations to modify the stake holders for, or the documents associated with, the business process, the process update component modifying the stake holders or the documents based on user actuation of the corresponding recommendation user input mechanism.

12. The computing system of claim 4 wherein the performance metric comprise a success metric indicative of a likely success of the business process, the process configuration component generating the process configuration display to display the success metric.

13. The computing system of claim 12 wherein the performance metrics comprise a timeliness metric indicative of a length of time likely used to complete the business process, the process configuration component, the process configuration component generating the process configuration display to display the timeliness metric.

14. A computing system, comprising:
an application system that runs an application to implement a running process and that generates a process display indicative of the running process;
an analytics accessing component that obtains analytics information, comprising metric information indicative of values for performance metrics for the running process, based on a configuration and state of the running process; and
a user interface component that displays the process display with the analytics information.

15. The computing system of claim 14 wherein the running process comprises a business process in a business system and wherein the metric information comprises key performance indicator values for a set of key performance indicators corresponding to the business process.

16. The computing system of claim 15 and further comprising:
a contextual surfacing component that surfaces the key performance indicators on the process display based on a context of the process display relative to the business process.

17. The computing system of claim 16 wherein the analytics information comprises recommendations to modify the running process, the application system generating recommendation user input mechanisms corresponding to the recommendations on the process display.

18. The computing system of claim 17 and further comprising:
a process update component that modifies the running process based on user actuation of the recommendation user input mechanisms, the application system updating the process display to reflect modifications made to the running process.

19. The computing system of claim 18 wherein the analytics accessing system accesses updated analytics information based on the modifications to the running process.

20. A method, comprising:
displaying a process display indicative of a structure of a process run in a computer system;
obtaining performance metric values for a set of performance metrics for the process;
obtaining a set of suggestions for modifying the process based on the performance metric values;
displaying the performance metric values for the performance metrics on the process display;
displaying user actuatable input mechanisms corresponding to the suggestions;
receiving user actuation of a given user actuatable input mechanism;
automatically taking action to modify the process based on the suggestion; and
updating the process display and the performance metric values based on the modification.
